(19) United States
(12) Patent Application Publication
(10) Pub. No.: US 2013/0080181 A1
(43) Pub. Date: Mar. 28, 2013

(54) TELEHEALTH CARE VERIFICATION AND AUDIT LOGGING SYSTEM

(71) Applicant: Matthew DePetro, Sunnyvale, CA (US)

(72) Inventor: Matthew DePetro, Sunnyvale, CA (US)

(73) Assignee: FUJITSU LIMITED, Kanagawa (JP)

(21) Appl. No.: 13/242,840

(22) Filed: Sep. 23, 2011

(51) Int. Cl. G06Q 50/00

(52) U.S. Cl. 705/2

(57) ABSTRACT

A method for providing telehealth services includes conducting a telehealth session between a provider and a patient, generating metadata associated with the telehealth session, and providing the metadata associated with the telehealth session to an auditing system for validating the telehealth session.

### TECHNICAL FIELD OF THE INVENTION

The present invention relates generally to healthcare information technology and, more particularly, to a telehealth care verification and audit logging system.

### BACKGROUND

In healthcare, once care for a patient has been provided a paper trail may exist to prove the provided services. Such a paper trail may be used to establish evidence for payors such as insurance companies. Payors may require evidence before paying a healthcare provider for products or services rendered to an insured patient. Furthermore, such a paper trail—or the lack thereof—may provide evidence for or in defense of an audit of the healthcare providers' services.

### SUMMARY

In one embodiment, a method for providing telehealth services includes conducting a telehealth session between a provider and a patient, generating metadata associated with the telehealth session, and providing the metadata associated with the telehealth session to an auditing system for validating the telehealth session.

In another embodiment, an article of manufacture includes a computer readable medium computer-executable instructions carried on the computer readable medium. The instructions are readable by a processor. The instructions, when read and executed, cause the processor to conduct a telehealth session between a provider and a patient, generate metadata associated with the telehealth session, and provide the metadata associated with the telehealth session to an auditing system for validating the telehealth session.

In yet another embodiment, a system for providing telehealth services includes a processor, a computer readable medium coupled to the processor, and computer-executable instructions carried on the computer readable medium. The instructions are readable by the processor. The instructions, when read and executed, cause the processor to conduct a telehealth session between a provider and a patient, generate metadata associated with the telehealth session, and provide the metadata associated with the telehealth session to an auditing system for validating the telehealth session.

In still yet another embodiment, a method for auditing telehealth services includes accessing metadata generated during a telehealth session, analyzing the metadata to determine whether the metadata validates or invalidates the telehealth session, and determining a level of certainty related to the validity of the telehealth session. The metadata is associated with the mechanism by which a party accessed the telehealth session.

In an additional embodiment, an article of manufacture includes a computer readable medium and computer-executable instructions carried on the computer readable medium. The instructions are readable by a processor. The instructions, when read and executed, cause the processor to access metadata generated during a telehealth session, analyze the metadata to determine whether the metadata validates or invalidates the telehealth session, and determine a level of certainty related to the validity of the telehealth session. The metadata associated with the mechanism by which a party accessed the telehealth session.

In another, additional embodiment, a system for validating telehealth services includes a processor, a computer readable medium coupled to the processor, and computer-executable instructions carried on the computer readable medium. The instructions are readable by the processor. The instructions, when read and executed, cause the processor to access metadata generated during a telehealth session, analyze the metadata to determine whether the metadata validates or invalidates the telehealth session, and determine a level of certainty related to the validity of the telehealth session. The metadata associated with the mechanism by which a party accessed the telehealth session.

### BRIEF DESCRIPTION OF THE DRAWINGS

For a more complete understanding of the present invention and its features and advantages, reference is now made to the following description, taken in conjunction with the accompanying drawings, in which:

FIG. 1 is an example embodiment of a system for telehealth care verification and audit logging;

FIG. 2 is an illustration of the operation of the system for telehealth care verification and audit logging;

FIG. 3 is an example embodiment of a metadata report;

FIG. 4 is another example embodiment of a metadata report; and

FIG. 5 is an example embodiment of a method for validating a telehealth session.

### DETAILED DESCRIPTION

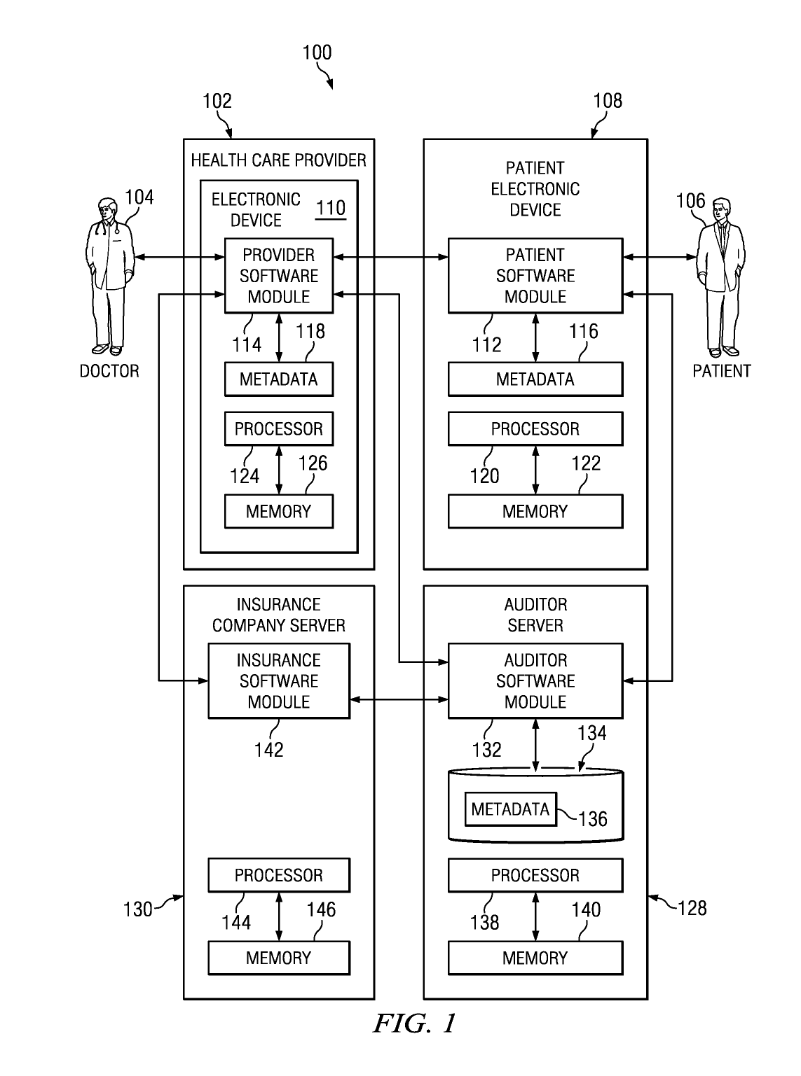

FIG. 1 is an example embodiment of a system 100 for telehealth care verification and audit logging. System 100 may include a healthcare provider 102 with an electronic device 110 communicatively coupled to a patient electronic device 108, an auditor server 128 communicatively coupled to the healthcare electronic device 110 and the patient electronic device 108, and an insurance company server 130 communicatively coupled to the auditor server 128 and the healthcare electronic device 110. Healthcare provider 102 may provide a doctor 104 to provide telehealth care services to a patient 106 through healthcare electronic device 110 and patient electronic device 108. Auditor server 128 may be configured to provide validation of claims submitted to an insurance company through insurance company server 130 by verifying metadata 116, 118 created as part of the telehealth communications between doctor 104 and patient 106.

Healthcare provider may provide healthcare electronic device 110 for doctor 104 to provide telehealth services to, for example, patient 106. Healthcare electronic device 110 may include provider software module 114. Provider software module 114 may be configured to enable telehealth consultation services to be provided to patient 106. Such telehealth consultation services include audio or video conferencing, self-serve options, medical condition or history validation, or any other suitable telehealth service interaction. Provider software module 114 may be configured to communicate with a patient software module 112 to provide such telehealth services. Provider software module 114 may be configured to generate metadata 118 as a result of such telehealth services. Metadata 118 may be stored within a file, record, database, or any other suitable mechanism. Provider software module 114 may be configured to send metadata 118 to auditor server 128. In one embodiment, provider software module 114 may be configured to provide metadata 118 to auditor server 128 on-demand, upon completion of a telehealth consultation session, periodically, or at any other suitable time. Electronic device 110 may include a processor 124 coupled to a memory 126. Instructions for provider software module 114 may reside within memory 126 for execution by processor 124. Although a single provider software module 114 is illustrated as a single module on electronic device 110, any suitable combination or number of electronic devices and software may be used to implement the functionality described herein. In one embodiment, provider software module 114 may execute on an electronic device that is remote to doctor 104 and/or health care provider 102. In such an embodiment, doctor 104 may access provider software module 114 through, for example, a thin client.

A patient 106 may use a patient electronic device 108 to access telehealth services. Patient 106 may use patient software module 112 operating on or through electronic device 108 to access such telehealth services. In one embodiment, patient software module 112 may be executing on patient electronic device 108. In another embodiment, patient software module 112 may be executing on an electronic device remote to patient electronic device 108. In such an embodiment, patient 106 may access patient software module 112 through, for example, a thin client. Patient software module 112 may be configured to enable telehealth consultation services to be provided to patient 106. Such telehealth consultation services include audio or video conferencing, self-serve options, medical condition or history validation, or any other suitable telehealth service interaction. Patient software module 112 may be configured to communicate with a provider software module 114 to access such telehealth services. Patient software module 112 may be configured to generate metadata 116 as a result of such telehealth services. Metadata 116 may be stored within a file, record, database, or any other suitable mechanism. Patient software module 112 may be configured to send metadata 116 to auditor server 128. In one embodiment, patient software module 112 may be configured to provide metadata 116 to auditor server 128 on-demand, upon completion of a telehealth consultation session, periodically, or at any other suitable time. Electronic device 110 may include a processor 120 coupled to a memory 122. Instructions for patient software module 112 may reside within memory 122 for execution by processor 120.

Auditor server 128 may include auditor software module 132. Auditor software module 132 may be configured to communicate with patient software module 112 and/or provider software module 114 to access metadata 116, 118 generated by the respective modules. Auditor software module 132 may be configured to access such metadata 116, 118 after the respective patient and provider modules terminate a telehealth consultation session, upon a request from an insurance company, periodically, or at any other suitable time. Auditor software module 132 may be configured to store metadata 136 received from other software modules with a any suitable mechanism, including metadata database 134. Metadata database 134 may include entries for telehealth transactions and the metadata associated with the transaction. Metadata database 134 may include historical information regarding various patients or doctors. Auditor server 128 may include a processor 138 coupled to a memory 140. Instructions for auditor software module 132 may reside within memory 140 for execution by processor 138. Although a single auditor software module 132 is illustrated as a single module on auditor server 128, any suitable combination or number of electronic devices and software may be used to implement the functionality described herein. In one embodiment, auditor server 128 may be operated by a third party auditing organization that provides auditing and verification services to, for example, insurance companies.

Insurance company server 130 may include insurance software module 142. Insurance software module 142 may be configured to handle claims or requests for reimbursement from a healthcare provider. Such a claim or request may originate from provider software module 114. Insurance software module 142 may be configured to access auditor server 128 to determine, in part, whether to allow or deny the claim or request for reimbursement. In one embodiment, a claims agent at an insurance company may directly access auditor server 128 for such a purpose. Based on the information received from auditor server 128, insurance software module 142 may be configured to allow, deny, or partially allow a claim or request for reimbursement. Insurance software module 142 may communicate such a decision to the healthcare provider through, for example, communication with provider software module 114. Although a single insurance software module 142 is illustrated as a single module on insurance company server 130, any suitable combination or number of electronic devices and software may be used to implement the functionality described herein. Insurance company server 130 may include a processor 144 coupled to a memory 146. Instructions for insurance software module 142 may reside within memory 146 for execution by processor 144.

Processors 120, 124, 138, 144 may comprise, for example, a microprocessor, microcontroller, digital signal processor (DSP), application specific integrated circuit (ASIC), or any other digital or analog circuitry configured to interpret and/or execute program instructions and/or process data. Processors 120, 124, 138, 144 may interpret and/or execute program instructions and/or process data stored in respective memories 122, 126, 140, 146. Memories 122, 126, 140, 146 may comprise any system, device, or apparatus configured to hold and/or house one or more memory modules. Each memory module may include any system, device or apparatus configured to retain program instructions and/or data for a period of time (e.g., computer-readable media).

Auditor server module 132 may be configured to analyze metadata to provide insurance software module a report regarding the respective records of a given telehealth consultation session. Auditor server module 132 may provide indications of whether or not such a consultation session occurred, the relative scope of the consultation session, or any other information suitable to verify a claim for payment for the session.

Metadata 116, 118 generated by provider and patient may be encrypted, digitally signed, or otherwise secured. Such security may be provided to guard against sniffing, hacking, or other unauthorized access, or to prevent fraud by a provider or a patient. In one embodiment, metadata 116, 118 may comprise non-confidential information. By using such non-confidential information, patient confidentiality may be better preserved.

Any suitable information may be stored in metadata 116, 118, 136 to verify a given healthcare consultation session. For example, metadata 116, 118, 136 may include a type of event (consultation, remote data acquisition, diagnostic event, etc.), unique terminal identification (computer name, media access control address), identity verification information, encryption key, the size of video or audio data received or sent, duration of event, start or end time, or terminal trust level confirmation. Information regarding terminal trust level confirmation may be found, for example, in U.S. Patent Application 2009/0172781, incorporated herein.

Auditor server module 132 may be configured to provide such metadata information to insurance company 130. In one embodiment, auditor server module 132 may be configured to analyze such metadata information to provide a recommendation to allow or deny a claim based on the metadata. In another embodiment, auditor server module 132 may be configured to provide a confidence level recommendation quantifying the level of certainty of which the claim should be paid.

The recipient of such analysis, such as an insurance company or insurance software module 142, may adopt the recommendation provided by auditor software module. In one embodiment, a recipient of a negative evaluation of a claim may trigger additional analysis of whether to allow such a claim, whereas a positive evaluation of a claim may be paid automatically.

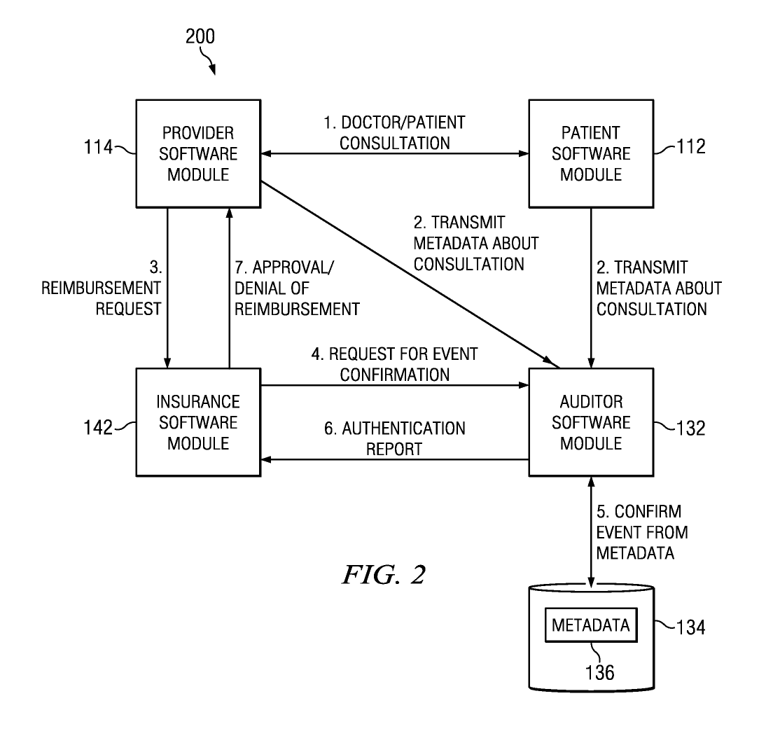

FIG. 2 is an illustration of the operation of system 100 for telehealth care verification and audit logging. At (1), a doctor and a patient may conduct a telehealth consultation. Consequently, at (2) provider software module 114 and patient software module 112 may generate metadata associated with the telehealth consultation and transmit the metadata to auditor software module 132. Auditor software module 132 may add the metadata to database 134.

At (3), a provider of healthcare services may make a reimbursement request for the telehealth consultation. Such a request may be made, for example, by the provider directly to the insurance company, or by the provider software module 114.

At (4), insurance software module 142 may send a request for confirmation of the telehealth consultation event from auditor software module 132. In one embodiment, such a request may be made by a claims agent of the insurance company to the auditor software module 132 directly.

At (5), auditor software module 132 may analyze the event from the metadata stored within database 134 to determine whether or not the telehealth consultation occurred, is reimbursable, or otherwise appears to be legitimate. Auditor software module 132 may determine a binary decision, a confidence level, a report listing factors, or any other suitable response and provide such a response in (6) back to the insurance software module 142.

Based on the reply from auditor software module 132, at (7) insurance software module 142 may accept or deny the reimbursement request. Depending upon the results received from auditor software module 132, insurance software module 142 may generate a follow-up investigation to determine whether to allow or deny the claim, or take additional appropriate action. Insurance software module 142 may compare the report or analysis received from auditor software module 132 against submitted expense reimbursement requests.

Auditor software module 132 may analyze metadata within database 134 to determine that a given telehealth transaction appears to be invalid, or does not match a given claim. For example, auditor software module 132 may determine that patient software module 112 and/or provider software module 114 did not create metadata at all associated with the given telehealth transaction, or that the metadata appears to be faked.

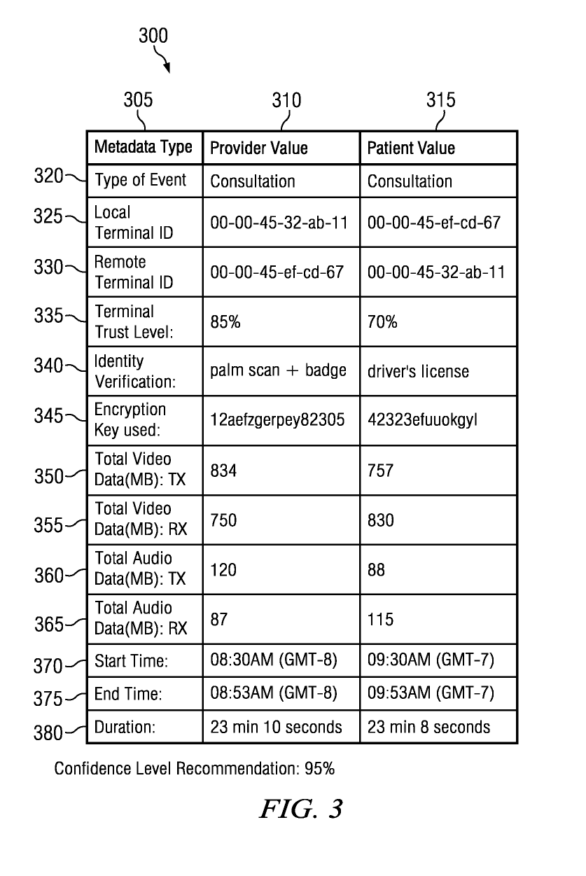

FIG. 3 is an example embodiment of a metadata report 300 as compiled by, for example, auditor software module 132. Metadata report 300 may also reflect the metadata as it is stored by auditor software module 132. Metadata report 300 may include fields for metadata type 305, a provider value 310, and a patient value 315. Metadata report 300 may include one or more factors used in analyzing the conformity of metadata as reported by provider and patient for a given telehealth session. Such factors may contribute to a recommendation by, for example, weighted values associated with each factor, multiplication of factors, or binary assessment. In one embodiment, some factors may be considered more heavily than other factors. In another embodiment, the assessment may be made by adding a normalized evaluation of each factor. In still yet another embodiment, the incongruence of a single, critical factor may yield a negative recommendation by auditor software module 132.

Metadata underlying metadata report 300 may include factors associated with any suitable metadata type. Metadata underlying metadata report 300 may include, for example, actual data arising from a telehealth session or such data modified to save space or preserve confidentiality.

Metadata report 300 may include metadata for type of event 320. The types of events may include a consultation, a diagnostic event, or a remote data acquisition. The type of session may be defined by patient software and/or doctor software during the telehealth session, and may be set by self-service selections by the patient or recommendations by the doctor. The type of session may be set by one or more devices used in the telehealth session, and may be set inherently or automatically during the telehealth session. The type of session may be set without action by the user to specifically set the type of session. For example, a telehealth session may be conducted from a data acquisition hub, wherein machines are provided for gathering physical data, such as blood pressure or temperature, from the patient. Since the data acquisition hub functions to gather telehealth data and provide it to health care providers, a session from such a data acquisition hub may be assumed to be a data acquisition session. Auditor software module 132 may be configured to analyze whether both the provider value and patient value are of the same type of event 320. Auditor software module 132 may incorporate such a determination into a final recommendations, such as a confidence level. For example, a discrepancy between the patient software and the doctor software for metadata for type of event 320 may cause auditor software module 132 to issue a rejection recommendation. In another example, congruence of such metadata may cause auditor software module 132 to add a percentage to a confidence level recommendation. In the example of metadata report 300, the values are equal which may indicate that the patient and the provider did conduct a telehealth session.

Metadata report 300 may include metadata for local terminal ID 325 and remote terminal ID 330. Local terminal ID 325 may include an identifier, such as a unique identifier, to identify an electronic device on which the metadata was generated. For a patient or provider software module, such a local terminal ID 325 may be an identifier of the electronic device upon which the software module conducted the telehealth session. Remote terminal ID 330 may include such an identifier of the electronic device to which the software module was connected to conduct the telehealth session. For example, for a patient software module the remote terminal ID 330 may include an identifier of the machine running the provider software module with which the patient conducted the telehealth session. Local terminal ID 325 and remote terminal ID 330 may include any suitable mechanism for identifying a terminal or electronic device from which a patient or provider conducts a telehealth session. For example, local terminal ID 325 and remote terminal ID 330 may include computer name, internet protocol (IP) address, webpage, media access control (MAC) address, or an identifier generated by patient or provider software. Auditor software module 132 may be configured to analyze whether the local terminal ID 325 of a provider is equal to the remote terminal ID 330 of the corresponding patient. Auditor software module 132 may be configured to analyze whether the local terminal ID 325 of the patient equals the remote terminal ID 330 of the provider. Auditor software module 132 may incorporate such a determination into a final recommendations, such as a confidence level. For example, a discrepancy between the terminal IDs, possibly showing that the telehealth session did not occur between the patient and the provider, may cause auditor software module 132 to issue a rejection recommendation. In another example, congruence of such metadata may cause auditor software module 132 to add a percentage to a confidence level recommendation. In the example of metadata report 300, the values are equal which may indicate that the patient and the provider did conduct a telehealth session.

In one embodiment, metadata report 300 may include indications of whether a terminal ID is typically used by a given patient or provider. Auditor software module 132 may access historical metadata information in database 134 to provide such indications. For example, a provider may typically use a given terminal or electronic device to provide telehealth sessions. Such sessions may generate metadata with the same local terminal ID 325. If a provider begins using an alternative terminal or electronic device to provide telehealth sessions, as indicated by generated metadata with different local terminal ID 325, auditor software module 132 may flag such behavior as suspicious. While providers may simply use a different available machine, it may reflect an attempt to subvert the auditing and verification system. Auditor software module 132 may factor such information into a lower confidence level recommendation, or recommend additional investigation.

Metadata report 300 may include metadata for terminal trust level 335 and identity verification 340. Terminal trust level 335 may be generated by a provider or patient software module based upon the identity verification provided. Such identity verification may be reflected in identity verification 340. Terminal trust level 335 may include a confidence level regarding the identity of the user of a patient or provider terminal. Terminal trust level 335 may thus provide a quantification or other indication of confidence that a telehealth session between the provider and the patient actually occurred. Identity verification 340 may include an indication of the types of verification that were used to identify the patient and/or the provider. Auditor software module 132 may incorporate terminal trust level 335 into final recommendations, such as a confidence level. For example, if terminal trust level 335 is below a minimum threshold value, auditor software module 132 may issue a rejection recommendation. In another example, the confidence level of terminal trust level 335 of the patient and/or the provider each may be normalized to be a maximum of ten percent of a confidence level recommendation. In the example of metadata report 300, the terminal trust level 335 of the provider may be 85% and the terminal trust level 334 of the patient may be 70%. Such values may be normalized to add a percentage to an overall confidence level recommendation. In the example of metadata report 300, identity verification 340 may indicate that the provider used a palm scan and a badge, and that the patient used a driver's license. Such identity verification may have been used to establish the terminal trust level 334.

Metadata report 300 may include metadata for the encryption key 345 used during the telehealth session. Encryption key 345 may be used, for example, by the patient or provider software module to encrypt the telehealth session itself or the generation of metadata. Auditor software module 132 may compare the encryption key 345 used by the patient and/or the provider against prior values used by the patient and/or the provider. Such an encryption key may be tied to the use of the telehealth software, and thus consistent use of the same encryption key may indicate continued valid use. A use of a different encryption key may be a factor indicating an attempt to circumvent the billing and auditing system. The encryption key may be assigned or licensed to a particular user or device. Auditor software module 132 may be configured to determine whether the encryption key is tied to the computer or user that used the encryption key. A discrepancy between the designated owner of the key and the user of the key may indicate an attempt to circumvent the billing and auditing system. Auditor software module 132 may evaluate whether the encryption key 345 is valid, based upon, for example, an internal checksum or determining whether the key is registered. An invalid key may indicate an attempt to circumvent the billing and auditing system. Based on one or more of these techniques, auditor software module 132 may be configured to add a percentage to a confidence level recommendation.

Metadata report 300 may include metadata for the information sent or received by the patient and the provider. Such information may include, for example, total video data sent 350, total video data received 355, total audio data sent 360, and total audio data received 365. Such information may be provided by the patient or provider software modules. Auditor software module 132 may be configured to determine whether the amount of data sent by the patient matches the amount of data received by the provider, and vice-versa. If there is a mismatch, auditor software module 132 may be configured to lower a confidence level recommendation, as such a mismatch may indicate that information has been falsified or that one side did not completely participate in the telehealth session. In one embodiment, if differences between the amount of data sent and received reaches a threshold amount, auditor software module 132 may be configured to give a rejection recommendation. Some discrepancies between the information sent and received may be naturally or honestly occurring. Thus, auditor software module 132 may be configured to allow for a degree of mismatched exchanged data without significantly negatively impacting a recommendation. In the example of metadata report 300, the provider may have sent eight-hundred thirty-four megabytes of video data to the patient, who may have received eight-hundred thirty megabytes. The provider may have sent one-hundred twenty megabytes of video data to the patient, who may have received one-hundred fifteen megabytes. The patient may have sent seven-hundred fifty-seven megabytes of video data to the provider, who may have received seven-hundred fifty megabytes. The patient may have sent eighty-eight megabytes of audio data to the provider, who may have received eighty-seven megabytes. Such close values of received and expected may cause auditor software module 132 to increase the confidence level recommendation.

Metadata report 300 may include metadata for the timing of the telehealth session. Such information may include, for example, start time 370, end time 375, and duration 380. Auditor software module 132 may be configured to compare the start times, end times, and duration values between the provider and the patient. Auditor software module 132 may be configured to consider time zone discrepancies between start or end times between the patient and the provider. Because start and end times may depend upon a local clock that is inaccurate, auditor software module 132 may be configured to use duration as a double-check on the start and end times. Duration 380 may have been issued by the patient and provider software modules. Auditor software module 132 may be configured to determine whether the start times, end times, and/or durations of the telehealth session as reported by the patient and the provider match. If there is a mismatch, auditor software module 132 may be configured to lower a confidence level recommendation, as such a mismatch may indicate that information has been falsified or that one side has overreported the length of the telehealth session. In one embodiment, if differences between the start times, end times, and/or duration reach a threshold, auditor software module 132 may be configured to give a rejection recommendation. In the example of metadata report 300, the start times 370 and the end times 375 of the provider and the patient may match. The duration 380 between the provider and the patient may be within two seconds of each other, an acceptable variance. Based on such information, auditor software module 132 may be configured to add a percentage to a confidence level recommendation.

Metadata report 300 may reflect a determination by auditor software module 132 whether to recommend or validate the metadata from the patient and provider. In one embodiment, such a determination may be a positive or negative recommendation. In another embodiment, such a determination may be a quantified confidence level. Such a quantified confidence level may be expressed in terms of a percentage of certainty.

In the example of metadata report 300, in which the metadata generally indicates that a telehealth session occurred and that the metadata of each participant largely matches, the metadata report 300 may indicate a positive recommendation validating the telehealth session. In one embodiment, the metadata report 300 may reflect a confidence level recommendation of 95%.

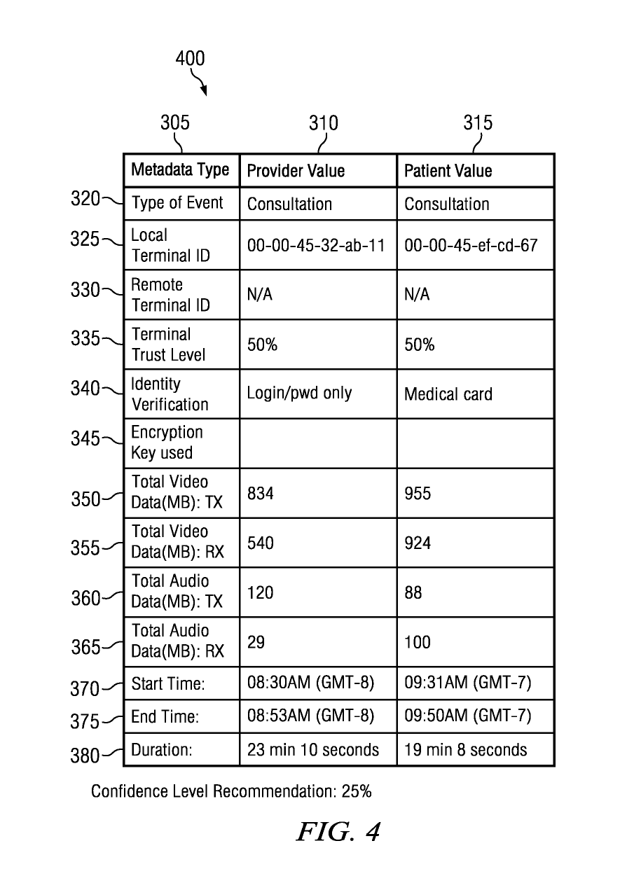

FIG. 4 is another example embodiment of a metadata report 400. Metadata report 400 may be configured in a similar fashion as and include similar metadata as metadata report 300. In the example of metadata report 400, the patient's terminal ID may have not been used in previous audit records. The new terminal ID may not alone determine that the telehealth session should not be validated, but may lead to the lowering of a confidence level recommendation. The type of event 320 may match and provide a positive impact on a confidence level recommendation.

Terminal trust level 335 may be of a low value, 50%. The patient may have provided only a medical insurance card, and the provider may have only logged in correctly to the telehealth system. Such methods may be easily faked, and as such the terminal trust level may be low. The lack of strong terminal trust level 335 may not alone determine that the telehealth session should not be validated, but may lead to the lowering of a confidence level recommendation.

In some cases, not all metadata may be available. For example, remote terminal ID 330 or encryption key 345 may not have been generated by the patient or the provider. Gathering such metadata may not have been supported by the terminal or the software used by the patient or the provider for telehealth communications. Such situations may arise when auditor software module 132 is maintained by a third party, and may be capable of interfacing with multiple types of telehealth services.

The amount of data exchanged between patient and provider in metadata report 400 may be significantly mismatched. The patient may have sent nine-hundred fifty-five megabytes of video data and the provider may have received five-hundred forty megabytes. The patient may have sent eighty-eight megabytes of audio data and the provider may have received twenty-nine. The provider may have sent eight-hundred thirty-four megabytes of video data and the patient may have received nine-hundred twenty-four. The provider may have sent one-hundred twenty megabytes of audio data and the patient may have received one-hundred. The discrepancy between the data transmitted by the patient (955 mb video, 88 mb audio) and the amount received by the provider (540 mb video, 29 audio) may be significant. Such a discrepancy may indicate that the session was not complete, or perhaps did not occur. Further, the indication that the patient received more video information (924 mb) than the provider transmitted (834) may indicate that the metadata for the patient and the provider is derived from different telehealth sessions. In such a case, the discrepancy may indicate that the telehealth session should not be verified.

A four-minute discrepancy between the durations 380 of the provider and patient metadata may tend to indicate that the health session should not be verified. Auditor software module 132 may decrease a confidence level recommendation as a result of such a discrepancy. However such a decreased recommendation may not be sufficient to form the sole basis of a negative recommendation.

In the example of metadata report 400, in which the metadata contains strong discrepancies about whether a telehealth session occurred as reported by the metadata, the metadata report 400 may indicate a negative recommendation, not validating the telehealth session. In one embodiment, the metadata report 400 may reflect a confidence level recommendation of 25%.

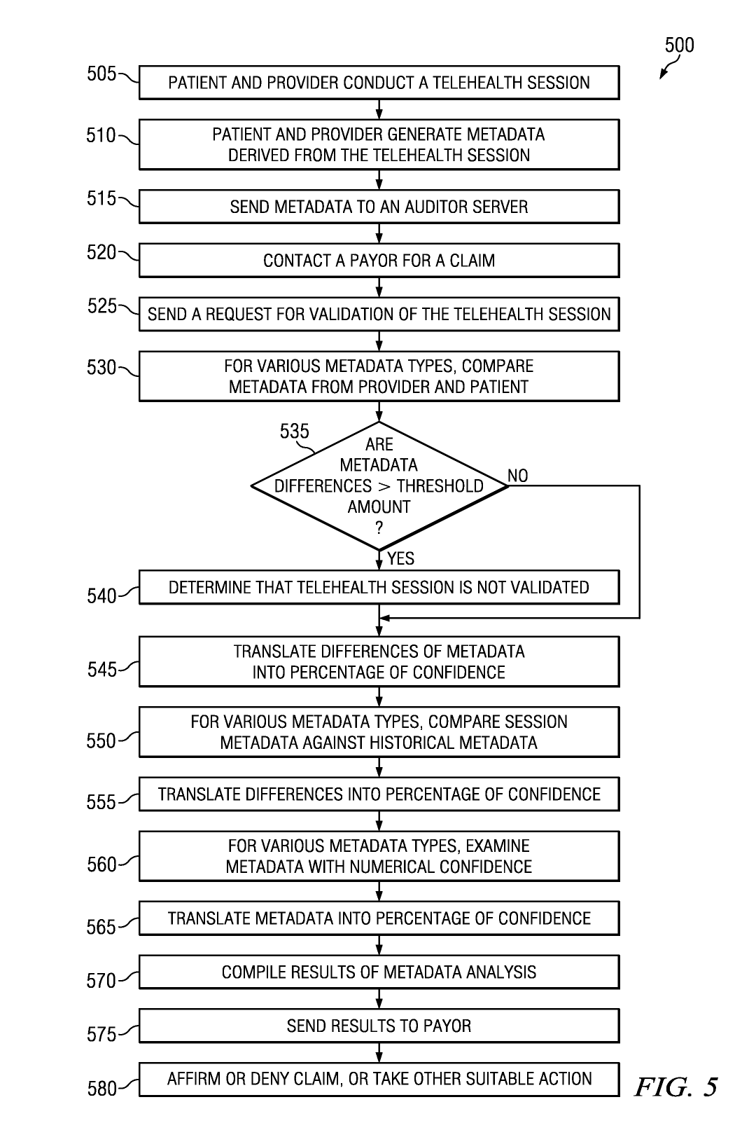

FIG. 5 is an example embodiment of a method 500 for validating a telehealth session. In step 505, a patient and a provider may allegedly conduct a telehealth session. The patient and/or the provider may conduct such a session using telehealth software and/or hardware. In step 510, the software used by the patient and/or the provider may generate metadata derived from the telehealth session. In step 515, the generated metadata may be sent to an auditor server of an auditing service. Such data may be sent periodically, on-demand, or at any other suitable time. The metadata may be stored in a database.

In step 520, the provider may contact a payor such as an insurance company for a claim arising from providing the telehealth session. The insurance company may validate the claim by using the auditing service. In step 525, a request for validation of the telehealth session may be sent to the auditor server, or to another server of the auditing service operable to access the metadata stored in the database.

The auditor server may validate the telehealth session based upon the metadata stored in the database. The auditor service may evaluate metadata such as identifiers of the machines used to provide the telehealth session, encryption data used, amount of video or audio data sent or received, terminal trust level, timing of the session, the type of session, or any other suitable metadata. For one or more given metadata types such as the amount of data between the patient and the provider, in step 530 the auditor service may compare such metadata generated by the provider and the patient. In one embodiment, in step 535 if the difference between metadata between the provider and the patient exceeds a threshold amount then in step 540 it may be determined that the telehealth session is not validated. The metadata values may be recorded, the method 500 may continue to check other metadata values, and the method 500 may proceed to step 545. If the difference between metadata between the provider and the patient does not exceed a threshold amount the method 500 may continue to check other metadata values, the metadata values may be recorded, and the method 500 may proceed to step 545.

In one embodiment, in step 545 for one or more given metadata types such as the amount of data between the patient and the provider, the differences between metadata of the provider and the patient may be translated into a quantification, such as a percentage of confidence.

In step 550, for one or more given metadata types such as the terminal identifier used to conduct the telehealth session may be compared against historical metadata. In step 555, any differences between the metadata may be translated into a quantification such as a percentage of confidence.

In step 560, for various metadata types a numerical confidence represented in the metadata may be examined. Such metadata types may include terminal trust levels. In step 565, the confidence values from the metadata may be translated into a quantification such as a percentage of confidence.

In step 570, the results of analyzing the metadata may be compiled. The results may be in the form of a percentage of numerical confidence. Such confidence may be derived from confidence values associated with available metadata. The results may be in the form of an affirmative or negative recommendation to validate the session. In one embodiment, a negative recommendation may be based on the presence of any determinations from step 540 that the telehealth should not be validated. An affirmative recommendation may be based on the absence of any such determinations from step 540. In another embodiment, a positive or negative recommendation may be based on whether a numerical confidence level to validate the session exceeds a threshold value, such as 75%.

In step 575, the results of the metadata analysis may be sent to the payor. In step 580, the payor may take suitable action in affirming the claim, denying the claim, or sending an alarm or flag to follow up for additional information. Such a determination may be made based on the recommendation from the auditor system, or upon the underlying metadata provided by the auditor system. The payor may reconcile the auditor's report with the payment request from the provider. The payor may compare the report with patient submitted expense reimbursement requests. If discrepancies are found between reimbursement requests and audit reports, the payor can choose to further scrutinize the transaction.

Although FIG. 5 discloses a particular number of steps to be taken with respect to example method 500, methods 500 may be executed with more or fewer steps than those depicted in FIG. 5. In addition, although FIG. 4 discloses a certain order of steps to be taken with respect to method 500, the steps comprising method 500 may be completed in any suitable order.

Method 500 may be implemented using the system of FIGS. 1-4 or any other system, network, or device operable to implement method 500. In certain embodiments, method 500 may be implemented partially or fully in software embodied in computer-readable media.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as non-transitory media; and/or any combination of the foregoing.

Although the present disclosure has been described in detail, it should be understood that various changes, substitutions, and alterations can be made hereto without departing from the spirit and the scope of the disclosure as defined by the appended claims.

What is claimed is:

1. A method for providing telehealth services, comprising:
conducting a telehealth session between a provider and a patient;
generating metadata associated with the telehealth session; and
providing the metadata associated with the telehealth session to an auditing system for validating the telehealth session.

2. The method of claim 1, wherein the generated metadata is generated from the patient's telehealth session.

3. The method of claim 1, wherein the generated metadata is generated from the provider's telehealth session.

4. The method of claim 1, wherein the generated metadata includes a classification of the type of telehealth session.

5. The method of claim 1, wherein the generated metadata includes an identifier of the terminal used by the provider.

6. The method of claim 1, wherein the generated metadata includes an identifier of the terminal used by the patient.

7. The method of claim 1, wherein the generated metadata includes a terminal trust level.

8. The method of claim 1, wherein the generated metadata includes methods used to verify the identity of one or more of the parties.

9. The method of claim 1, wherein the generated metadata includes an encryption key.

10. The method of claim 1, wherein the generated metadata includes an amount of information sent from the patient to the provider during the telehealth session.

11. The method of claim 1, wherein the generated metadata includes an amount of information sent from the provider to the patient during the telehealth session.

12. The method of claim 1, wherein the generated metadata includes an amount of information received by the patient from the provider during the telehealth session.

13. The method of claim 1, wherein the generated metadata includes an amount of information received by the provider from the patient during the telehealth session.

14. The method of claim 1, wherein the generated metadata includes the timing of the session as generated from the patient.

15. The method of claim 1, wherein the generated metadata includes the timing of the session as generated from the provider.

16. An article of manufacture, comprising:
a computer readable medium; and
computer-executable instructions carried on the computer readable medium, the instructions readable by a processor, the instructions, when read and executed, for causing the processor to:
conduct a telehealth session between a provider and a patient;
generate metadata associated with the telehealth session; and
provide the metadata associated with the telehealth session to an auditing system for validating the telehealth session.

17. A system for providing telehealth services, comprising:
a processor;
a computer readable medium coupled to the processor; and
computer-executable instructions carried on the computer readable medium, the instructions readable by the processor, the instructions, when read and executed, for causing the processor to:
conduct a telehealth session between a provider and a patient;
generate metadata associated with the telehealth session; and
provide the metadata associated with the telehealth session to an auditing system for validating the telehealth session.

18. A method for auditing telehealth services, comprising:
accessing metadata generated during a telehealth session, the metadata associated with the mechanism by which a party accessed the telehealth session;
analyzing the metadata to determine whether the metadata validates or invalidates the telehealth session; and
determining a level of certainty related to the validity of the telehealth session.

19. The method of claim 18, wherein the metadata comprises:
patient metadata associated with the mechanism by which the patient accessed the telehealth session; and
provider metadata associated with the mechanism by which the provider accessed the telehealth session;

20. The method of claim 19, wherein analyzing the metadata comprises:
comparing a portion of the patient metadata and with an analogous portion of the provider metadata;
determining whether the differences between the patient metadata and the provider metadata exceed a threshold; and
if the differences exceeds the threshold, determining that the telehealth session should not be validated.

21. The method of claim 19, wherein analyzing the metadata comprises:
comparing the patient metadata and the provider metadata;
determining the differences between the patient metadata and the provider metadata; and
quantifying the confidence in validity of the session with regards to the portions of the metadata.

22. The method of claim 18, further comprising:
receiving a request from a payor for a validation of the telehealth session;
providing a recommendation to the payor regarding the validity of the telehealth session.

23. The method of claim 22, wherein providing a recommendation comprises:
if the level of certainty related to the validity of the telehealth session exceeds a threshold value, recommending that the telehealth session was valid.

24. An article of manufacture, comprising:
a computer readable medium; and
computer-executable instructions carried on the computer readable medium, the instructions readable by a processor, the instructions, when read and executed, for causing the processor to:
access metadata generated during a telehealth session, the metadata associated with the mechanism by which a party accessed the telehealth session;
analyze the metadata to determine whether the metadata validates or invalidates the telehealth session; and
determine a level of certainty related to the validity of the telehealth session.

25. A system for validating telehealth services, comprising:
a processor;
a computer readable medium coupled to the processor; and
computer-executable instructions carried on the computer readable medium, the instructions readable by the processor, the instructions, when read and executed, for causing the processor to:
access metadata generated during a telehealth session, the metadata associated with the mechanism by which a party accessed the telehealth session;
analyze the metadata to determine whether the metadata validates or invalidates the telehealth session; and
determine a level of certainty related to the validity of the telehealth session.
